(19) United States
(12) Patent Application Publication
(10) Pub. No.: US 2007/0098357 A1
(43) Pub. Date: May 3, 2007

(54) DVR content skip navigation

(75) Inventors: Elizabeth Rose McEnroe, Palo Alto, CA (US); Thomas H. Taylor, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/260,948

(22) Filed: Oct. 28, 2005

(51) Int. Cl. H04N 5/91

(52) U.S. Cl. 386/68

(57) ABSTRACT

DVR content skip navigation is described. In an embodiment, a video system renders video for display at a playback speed for viewing. An input can be received to initiate a fast review of the video for a designated duration during which the video is viewable. After the designated duration of fast review, the video automatically returns to the playback speed for viewing.

### BACKGROUND

Television-based client devices, such as a digital video recorder (DVR), can be implemented to receive and record media content in the form of programs, on-demand videos, movies, and any other type of broadcast and/or interactive television-based entertainment and information. A digital video recorder includes a hard disk memory so that a viewer can record media content of interest to the viewer.

The advent of on-demand programming, such as with recorded or cached on-demand and broadcast media content, as well as IP-based television (IPTV) media content, provides a viewer with the option to navigate a recorded program or on-demand media with media content navigation features commonly referred to as “trick modes”. These media content navigation features are typically initiated with a remote control device and include commands such as fast-forward, skip-ahead in the program, skip to a next segment, pause the program, and the like.

Some remote control devices are implemented with a “skip” button (e.g., a jump-ahead navigation control input) that can be selected to jump over advertisements in recorded or on-demand programming. While beneficial when used to shorten the time for viewing a recorded program, a “skip” input enables a viewer to jump past and ignore advertisements that are broadcast between segments of the program. These advertisements for products and services are typically a primary source of revenue for a provider of the media content. As more viewers attain the ability to jump past the advertisements in their programming choices, advertisers will become unwilling to have their advertising messages communicated in the traditional manner.

Some content providers have opted to remove the skip functionality from the remote control devices provided with a television-based service, leaving only the fast-forward function. However, the fast-forward function does not provide a convenient media content advance function for skipping segments of a recorded program, such as television commercials, because the video that is being displayed must be observed by the viewer to input another remote control input, such as another fast-forward or play input, at precisely the right time to keep from overrunning a commercial and missing part of the recorded or on-demand program.

### SUMMARY

This summary is provided to introduce simplified concepts of digital video recorder (DVR) content skip navigation which is further described below in the Detailed Description. This summary is not intended to identify essential features of the claimed subject matter, nor is it intended for use in determining the scope of the claimed subject matter.

In an embodiment of DVR content skip navigation, a video system, such as a television-based client device, renders video for display at a playback speed for viewing. A skip input can be received, such as from a user-selectable input via a television-based remote control device. The skip input initiates a fast review of the video for a designated duration during which the video is viewable. After the designated duration of fast review, the video automatically returns to the playback speed for viewing without receiving an additional user-selectable input.

In another embodiment of DVR content skip navigation, a skip input is received as a skip advance to initiate fast-forwarding through the video for the designated duration. After fast-forwarding through the video for the designated duration, the video automatically resumes displaying at the playback speed for viewing. Optionally, the speed at which the video is fast-forwarded through may vary and/or be adjustable. For example, the fast-forward speed may be accelerated at or near the beginning of the designated duration and then decelerate at or near the end of the designated duration when fast-forwarding through the video.

In another embodiment of DVR content skip navigation, a skip input is received as a skip reverse to initiate rewinding through the video for the designated duration. After rewinding through the video for the designated duration, the video automatically resumes displaying at the playback speed for viewing.

In another embodiment of DVR content skip navigation, a skip input is received as a continuous fast-forward input signal to initiate the fast review of the video. The designated duration is a time duration during which the continuous fast-forward input signal is received, after which the video automatically resumes displaying at the playback speed for viewing when the continuous fast-forward input signal is no longer received.

### BRIEF DESCRIPTION OF THE DRAWINGS

The same numbers are used throughout the drawings to reference like features and components.

FIG. 1 illustrates an exemplary DVR content system in which embodiments of DVR content skip navigation can be implemented.

FIG. 2 illustrates exemplary method(s) for DVR content skip navigation.

FIG. 3 illustrates an exemplary IP-based television (IPTV) system in which embodiments of DVR content skip navigation can be implemented.

FIG. 4 illustrates various components of an exemplary client device in which embodiments of DVR content skip navigation can be implemented.

FIG. 5 illustrates various devices and components in an exemplary entertainment and information system in which embodiments of DVR content skip navigation can be implemented.

### DETAILED DESCRIPTION

Digital video recorder (DVR) content skip navigation is described in which embodiments provide that a viewer can skip a segment of a video that is being displayed for viewing at a playback speed. A skip input can be a skip advance to initiate fast-forwarding through the video for an optionally configurable amount of time (e.g., a designated duration). For example, a viewer may use a television-based remote control device having a user-selectable skip input control or button to skip through a thirty (30) second commercial or the approximate twenty (20) seconds between plays in a football game. The optionally configurable amount of time for a skip advance can be configured by an operator (e.g., a content provider) and may be based on agreements that designate how long the skip duration should be and at what fast-forward rate.

After fast-forwarding through a commercial, the down time between plays in a football game, or any other video segment, the video automatically resumes displaying at the playback speed for viewing without an additional viewer input. A skip input can also be a skip reverse to initiate rewinding through the video for the designated duration, after which the video automatically resumes displaying at the playback speed for viewing without an additional viewer input.

A user-selectable skip input control or button on a television-based remote control device provides a viewer the preset skip functionality to fast-forward and/or rewind through the video for an incremental duration. A viewer selectable skip “mode” provides the viewer with the option to navigate through any part of a video stream with a fast advance (e.g., fast-forward) or a fast reverse (e.g., rewind) for a designated duration of time without having to continuously monitor the display for the exact moment to enter a second input to resume viewing the video. As such, the viewer can “smooth-scroll” through a segment of the video while still being able to see the content of the segment that is being skipped through.

Alternatively, a skip input can be a continuous fast-forward input signal from a viewer with a television-based remote control device to initiate the fast review of the video. The designated duration is a time duration during which the continuous fast-forward input signal is received, after which the video automatically resumes displaying at the playback speed for viewing when the continuous fast-forward input signal is no longer received. Similarly, a skip input can be a continuous rewind input signal to initiate the fast review of the video.

While aspects of the described systems and methods for DVR content skip navigation can be implemented in any number of different computing systems, environments, television-based entertainment systems, and/or configurations, embodiments of DVR content skip navigation are described in the context of the following exemplary system architecture(s).

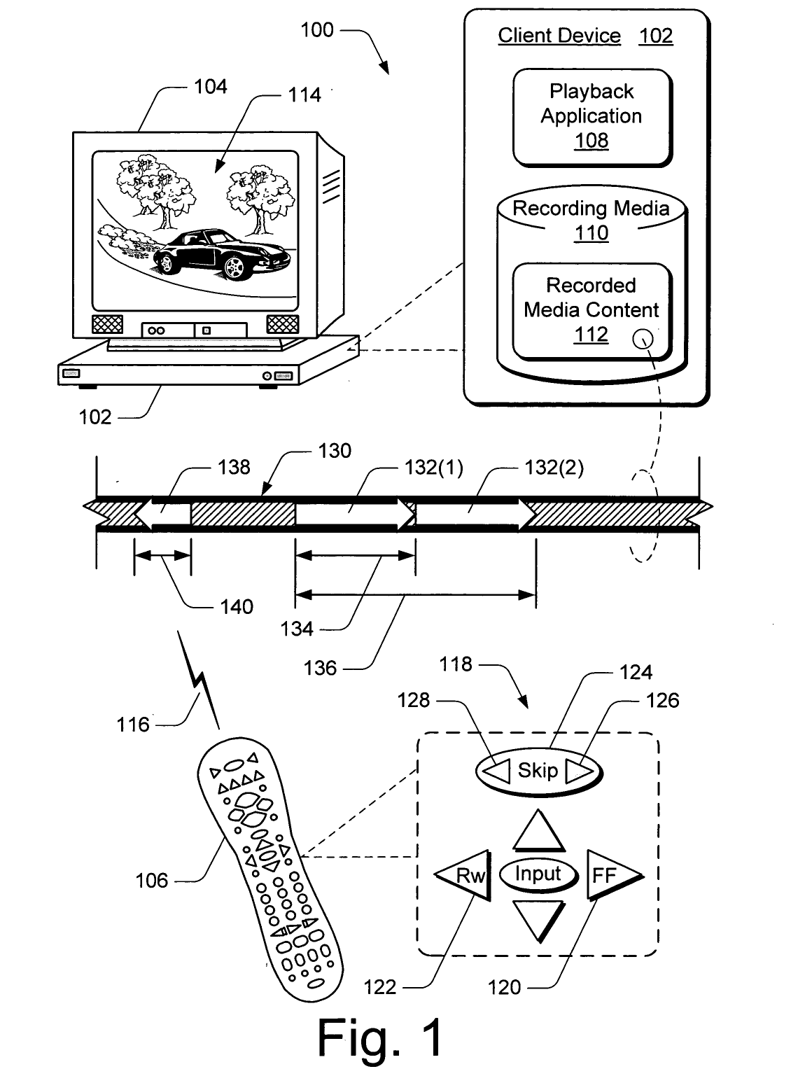

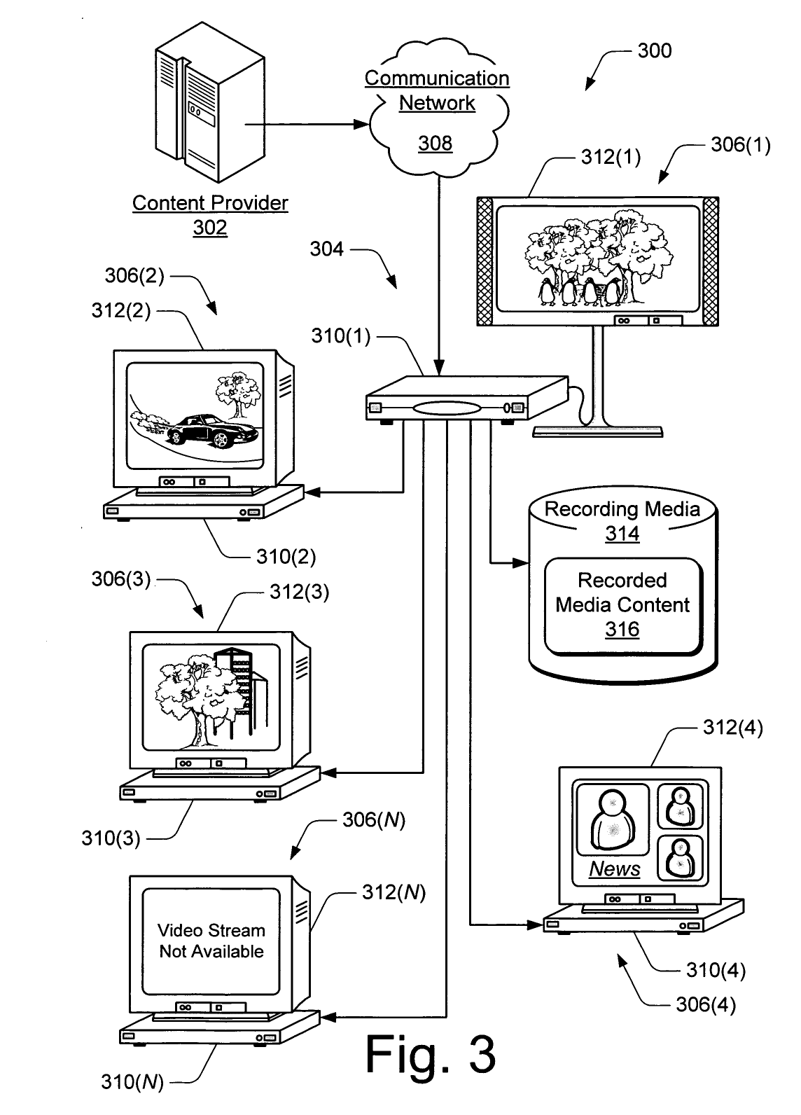

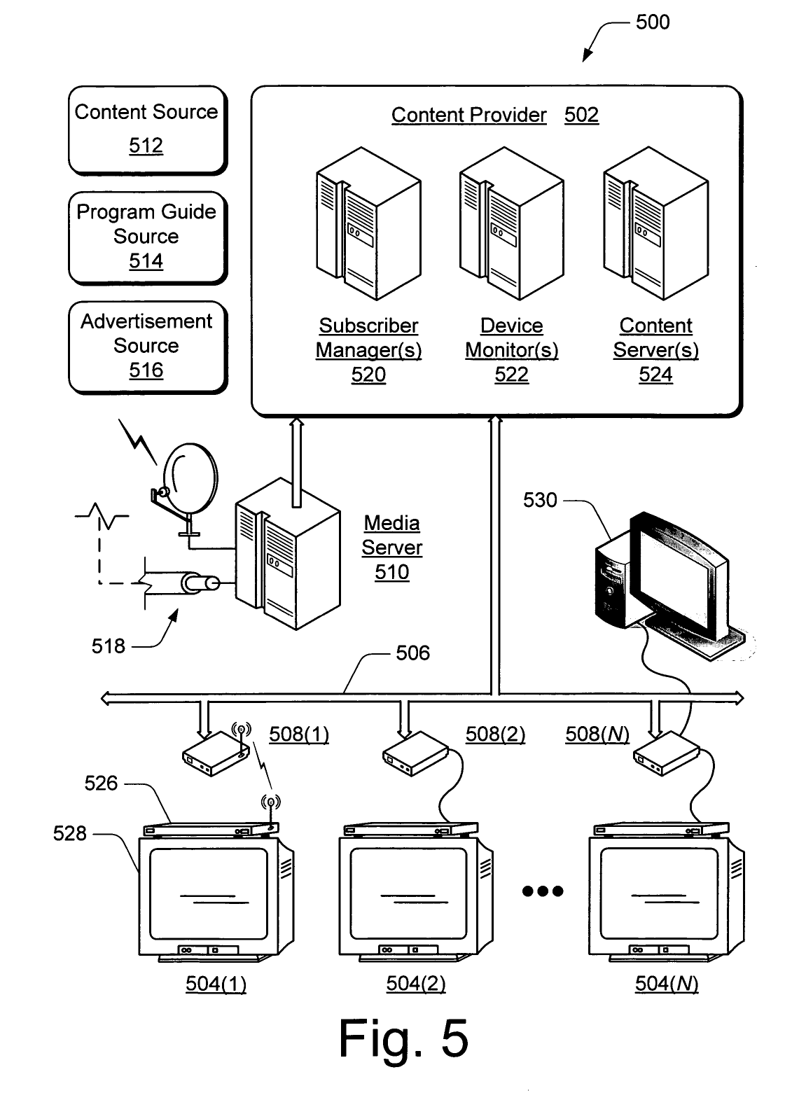

FIG. 1 illustrates an exemplary digital video recorder (DVR) system 100 in which embodiments of DVR content skip navigation can be implemented. The DVR system 100 includes a client device 102, a display device 104, and a television-based remote control device 106. The display device 102 can be any type of television, monitor, or similar television-based display system that renders audio, video, and/or image data. The client device 102 and display device 104 together are but one example of a television-based client system, examples of which are described with reference to the exemplary IP-based television (IPTV) system 300 shown in FIG. 3, and with reference to the exemplary entertainment and information system 500 shown in FIG. 5.

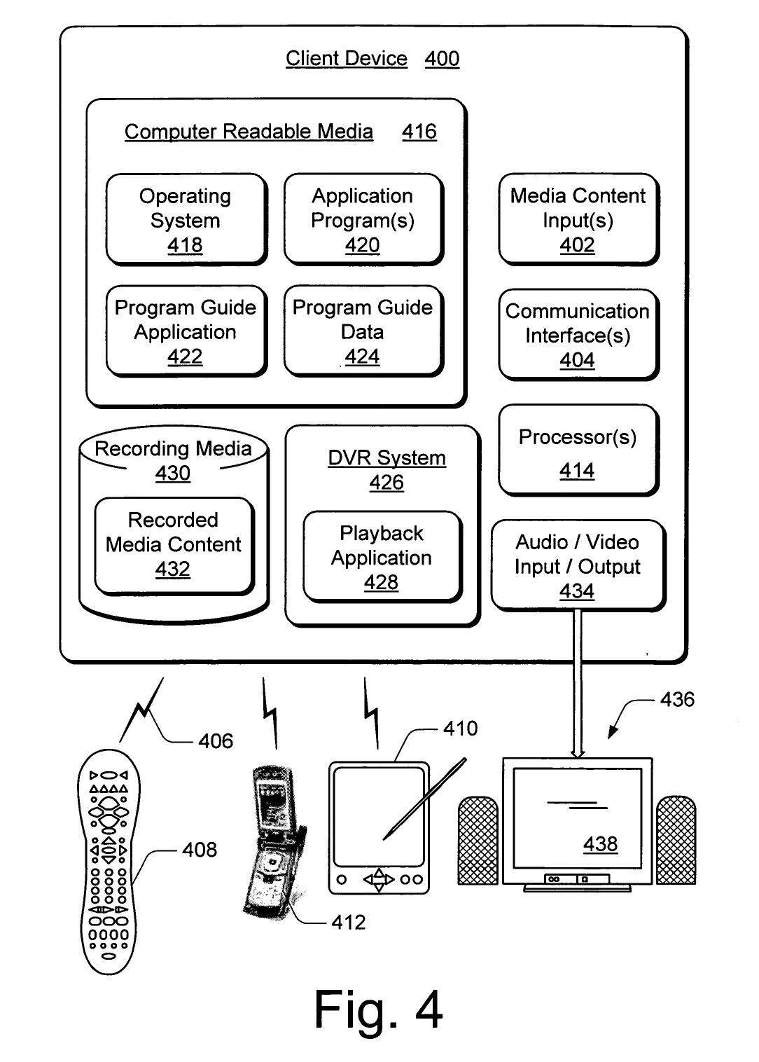

Client device 102 can be implemented in any number of embodiments, such as a set-top box, a digital video recorder (DVR) and playback system, an appliance device, and as any other type of client device that may be implemented in a television-based entertainment and information system. In this example, client device 102 includes a playback application 108 and a recording media 110 that maintains recorded media content 112. Additionally, client device 102 may be implemented with any number and combination of differing components as further described below with reference to the exemplary client device 400 shown in FIG. 4.

Recording media 112 can be implemented as a DVR system to record and maintain the recorded media content 112 which may be any form of on-demand and/or broadcast media content such as programs, movies, commercials, music, and similar audio, video, and/or image content that client device 102 receives and/or records. Further, client device 102 may access or receive additional recorded media content that is maintained with a remote data store (not shown), such as from a video-on-demand server, or media content that is maintained at a broadcast center or content provider that distributes the media content to subscriber sites and client devices.

The playback application 108 is a video control application that, in this example, can be implemented to control the playback of media content, such as the recorded media content 112, or other video on-demand media content, music, a slideshow, and any other audio, video, and/or image media content which can be rendered and/or displayed for viewing as video 114 on the display device 104. Further, the playback application 122 is implemented to receive user-selectable content navigation input commands 116, such as from the remote control device 106.

In this example, the television-based remote control device 106 includes various configuration and television-specific input keys, an input keypad, and various user-selectable input controls 118. The input controls 118 include a fast-forward input control 120, a rewind input control 122, and a skip input control 124. Optionally, the skip input control 124 may be implemented to include a skip-advance input control 126 and/or a skip-reverse input control 128, or may be a toggle switch that functionally implements a skip-advance and/or a skip-reverse.

This example system 100 also includes a representation of a video stream 130 which can represent video data corresponding to recorded media content 112 being rendered for display as video 114 on the display device 104. In an embodiment of DVR content skip navigation, a viewer can initiate a skip function via the skip input control 124 on the television-based remote control device 106. The playback application 108 at client device 102 receives and processes the user-selectable skip input to initiate a fast review of the video stream 130 for a designated duration during which the video 114 is still viewable. For example, the skip input can be a skip advance 132(1) to initiate fast-forwarding through the video stream 130 for an optionally configurable amount of time 134 (e.g., a designated duration, such as thirty (30) seconds).

The playback application 108 is also implemented to automatically resume display of the video 114 at the playback speed for viewing after the skip advance 132(1) without an additional viewer input from the remote control device 106. This is contrary to a conventional fast-forward type of input when a viewer would then continuously monitor the display for the exact moment to enter a second input, such as “play”, to resume viewing the video. With DVR content skip navigation as described herein, a viewer can enter a skip input to initiate a fast review 132(1) of the video stream 130 (e.g., forward or reverse) without having to enter a second input to then resume displaying the video 114 on display device 104.

In another embodiment of DVR content skip navigation, a viewer can initiate a first skip advance 132(1) via the skip input control 124 on the television-based remote control device 106 followed by a second skip advance 132(2). The playback application 108 at client device 102 receives and processes the user-selectable skip inputs 132(1-2) to initiate fast-forwarding through the video stream 130 for twice the designated duration 136. For example, a viewer can press or select the skip input control 124 any number of consecutive times to fast-forward through the video stream 130. If the designated duration for a skip input is thirty (30) seconds, then a viewer can skip advance, or fast-forward, through two (2) minutes of the video stream 130 by pressing and releasing the skip input control 124 four (4) times in succession. At the end of the two (2) minute skip advance, the video 114 automatically resumes displaying at the playback speed.

In another embodiment of DVR content skip navigation, the playback application 108 at client device 102 receives and processes a user-selectable skip input to initiate a fast review of the video stream 130 for a designated duration during which the video 114 is still viewable. For example, the skip input can be a skip reverse 138 (also referred to as “replay”) to initiate rewinding through the video stream 130 for an optionally configurable amount of time 140 (e.g., a designated duration, such as ten (10) seconds). The playback application 108 is also implemented to automatically resume display of the video 114 at the playback speed for viewing after the skip reverse 138 without an additional viewer input from the remote control device 106.

In another embodiment of DVR content skip navigation, a viewer can press and hold the fast-forward input control 120 on the remote control device 106 to input a continuous fast-forward input signal 116 to the client device 102. The playback application 108 receives and processes the input signal 116 to initiate a fast-forward review of the video stream 130 until such time that the continuous fast-forward input signal is no longer received. The designated duration of the fast-forward review is a time duration during which the continuous fast-forward input signal is received, after which the video automatically resumes displaying at the playback speed for viewing when the continuous fast-forward input signal is no longer received. In a similar manner, a viewer can press and hold the rewind input control 122 on the remote control device 106 to input a continuous rewind input signal to the client device 102. The playback application 108 receives and processes the rewind input signal to initiate a fast rewind review of the video stream 130 until such time that the continuous rewind input signal is no longer received.

In one embodiment, the skip input functionality can be implemented by adding to the existing fast-forward and rewind functions in the embedded programming (i.e., hardware, software, and/or firmware) built into a television-based remote control device 106. The remote control device 106 can be implemented with a microcontroller to detect a skip input and automatically generate start/stop timing pulses that are communicated to the client device 102 to indicate the duration of fast review (e.g., forward or reverse). Alternatively and/or in addition, the client device 102 can be implemented to detect the skip input signals received from the television-based remote control device 106 and process the skip input signals, such as with playback application 108.

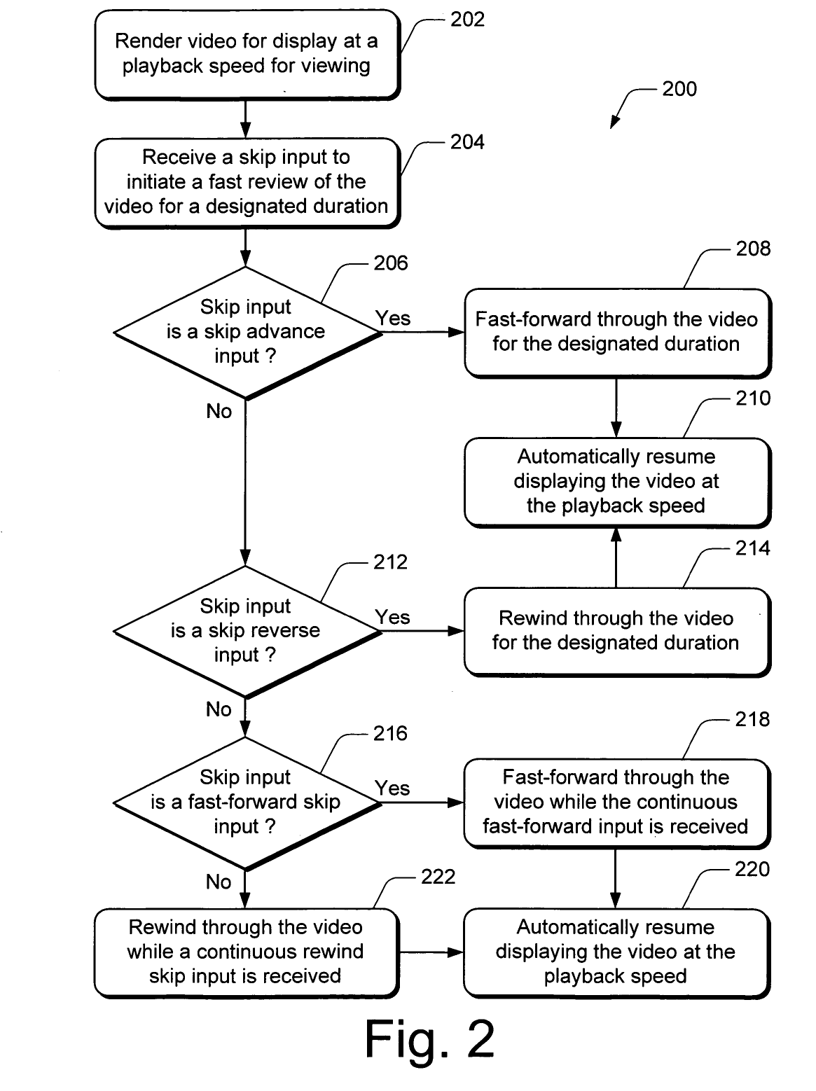

Methods for DVR content skip navigation, such as exemplary method 200 described with reference to FIG. 2, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 2 illustrates an exemplary method 200 for DVR content skip navigation. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 202, video is rendered for display at a playback speed for viewing. For example, playback application 108 at client device 102 is a video control application that controls playback of video 114 displayed for viewing on the display device 104. At block 204, a skip input is received to initiate a fast review of the video for a designated duration. For example, client device 102 receives a user-selectable skip input 116 from the remote control device 106 and processes the skip input to fast-forward or rewind through the video stream 130 such that the displayed video 114 is still viewable.

At block 206, a determination is made as to whether the received skip input is a skip advance input. If the received skip input is detected as a skip advance input (i.e., “yes” from block 206), then the video fast-forwards for the designated duration at block 208. For example, the playback application 108 at client device 102 initiates fast-forwarding through the video stream 130 for an optionally configurable amount of time 134. At block 210, the video automatically resumes displaying at the playback speed after fast-forwarding through the video for the designated duration, and without receiving an additional user-selectable input.

If the received skip input is not a skip advance input (i.e., “no” from block 206), then a determination is made as to whether the received skip input is a skip reverse input at block 212. If the received skip input is detected as a skip reverse input (i.e., “yes” from block 212), then the video rewinds for the designated duration at block 214. For example, the playback application 108 at client device 102 initiates rewinding through the video stream 130 for an optionally configurable amount of time 140. At block 210, the video automatically resumes displaying at the playback speed after rewinding through the video for the designated duration, and without receiving an additional user-selectable input.

If the received skip input is not a skip reverse input (i.e., “no” from block 212), then a determination is made as to whether the received skip input is a fast-forward skip input at block 216. If the received skip input is detected as a fast-forward skip input (i.e., “yes” from block 216), then the video fast-forwards while the continuous fast-forward skip input is received at block 218. For example, the playback application 108 at client device 102 initiates fast-forwarding through the video stream 130 while the continuous fast-forward skip input signal is being received. At block 220, the video automatically resumes displaying at the playback speed when the continuous fast-forward skip input signal is no longer received, and without receiving an additional user-selectable input.

If the received skip input is not a fast-forward skip input (i.e., “no” from block 216), then the received skip input is a rewind skip input and the video rewinds while the continuous rewind skip input is received at block 222. For example, the playback application 108 at client device 102 initiates rewinding through the video stream 130 while the continuous rewind skip input signal is being received. At block 220, the video automatically resumes displaying at the playback speed when the continuous rewind skip input signal is no longer received, and without receiving an additional user-selectable input. The method 200 can then continue at block 204 to receive an additional skip input that would be processed with the first skip input to initiate the fast review of the video for twice the designated duration.

FIG. 3 illustrates an exemplary IP-based television (IPTV) environment 300 in which embodiments of DVR content skip navigation can be implemented. The IPTV environment 300 includes a content provider 302 and a viewing system 304 that can include any number of television-based client systems 306. A client system 306(1) is configured for communication with the content provider 302 via a communication network 308 which, in this example, is an IP-based network. In addition to the client system 306(1), the viewing system 304 includes television-based client systems 306(2−N), and can represent a household viewing system that has several viewing areas, such as different rooms, for viewing television programming.

Television-based programs may include any form of programs, commercials, music, movies, video on-demand movies and other media content, recorded media content, interactive games, network-based applications, and any other similar audio, video, and/or image content. In addition, programming in general may include music streamed from a computing device to a client device, such as a television-based set-top box, and may also include video on-demand media content delivered from a server, a photo slideshow, and any other audio, video, and/or image content received from any type of media content source.

The television-based client systems 306(1−N) may be implemented with any number and combination of differing components as further described below with reference to the exemplary client device 400 shown in FIG. 4. Further, the IPTV environment 300 may be implemented with any number and combination of differing components as described below with reference to the exemplary entertainment and information system 500 shown in FIG. 5.

The television-based client system 306(1) includes a client device 310(1) and a display device 312(1), such as any type of television, monitor, or similar television-based display system that renders audio, video, and/or image data. Similarly, the television-based client systems 306(2−N) each include a respective client device 310(2−N) and a respective display device 312(2−N). Each client device 310 can be implemented in any number of embodiments, such as a set-top box, a digital video recorder (DVR) and playback system, a personal video recorder (PVR), an appliance device, and as any other type of client device that may be implemented in a television-based entertainment and information system.

Client device 310(1) receives program content from content provider 302 via the communication network 308. In the example viewing system 304, client device 310(1) is a master client device that receives one or more data streams from content provider 302 and then arbitrates stream allocation to distribute the data streams, one each, to one or more of the other satellite client devices 310(2−N). The satellite client devices 310(2−N) connect to the master client device 310(1) to receive a data stream for live television, delayed program viewing, and/or recorded DVR playback. The data streams are allocated by the content provider to the viewing system 304 (e.g., a household), and the data streams can be any combination of high definition and/or standard definition television data streams. For example, the viewing system 304 may receive one high definition data stream and three standard definition data streams depending upon available bandwidth to deliver the data streams. As more bandwidth becomes available, a viewing system may receive more high definition and/or standard definition data streams.

Although the data streams are not shown specifically, the arrowed communication links illustrate various data communication links which include the data streams. Additionally, the arrowed communication links are not intended to be interpreted as a one-way communication link from client device 310(1) to client device 310(2), for example. It is contemplated that any one or more of the arrowed communication links can facilitate two-way data communication, such as from client device 310(2) to client device 310(1) for example, and from client device 310(1) to content provider 302.

In this system, the master client device 310(1) receives four (4) data streams from the content provider 302 via the communication network 308. A viewing selection from a first data stream is shown for viewing on display device 312(1) at the television-based client system 306(1). A second data stream is directed from the master client device 310(1) to the television-based client system 306(2) and a viewing selection from a second data stream is shown for viewing on display device 312(2). Similarly, a third data stream is directed from the master client device 310(1) to the television-based client system 306(3) and a viewing selection from the third data stream is shown for viewing on display device 312(3). Additionally, a fourth data stream is directed from the master client device 310(1) to the television-based client system 306(4) and a viewing selection from the fourth data stream is shown for viewing on display device 312(4).

The available bandwidth for a viewing system, or household as in this example, may not be able to accommodate as many data streams as there are client devices. It is not unusual for a household to have five (5) or more televisions in various rooms and at various locations throughout the house. In this system, the number of client devices exceeds the number of data streams allocated to the viewing system 304 from the content provider 302. For example, the viewing system 304 includes at least a fifth satellite client device 310(N) of the television-based client system 306(N). The corresponding display device 312(N) indicates that no video stream is available because the four (4) data streams allocated to the viewing system 304 are already being directed to the other client devices 310(1-4).

The viewing system 304 also includes recording media 314 which can be implemented as a DVR system to record and maintain media content 316, such as any form of programs, movies, and similar audio, video, and/or image content that may be distributed or otherwise received from content provider 302. In one embodiment, the recording media can be implemented as an independent component of the viewing system 304 and connected to the master client device 310(1). Alternatively, the recording media 314 can be implemented as a component of the master client device 310(1) which manages recordings initiated from any of the other satellite client devices 310(2−N). In yet another embodiment, the recording media 314 may be a distributed recording system where any one or more of the client devices 310(1−N) include recording media that is centrally managed by the master client device 310(1).

FIG. 4 illustrates various components of an exemplary client device 400 which can be implemented as any form of a computing, electronic, and/or television-based client device, and in which embodiments of DVR content skip navigation can be implemented. For example, the client device 400 can be implemented as the television-based client device 102 shown in FIG. 1 and/or as any one of the television-based client devices 310(1−N) shown in FIG. 3 as part of the viewing system 304.

Client device 400 includes one or more media content inputs 402 which may include Internet Protocol (IP) inputs over which streams of media content are received via an IP-based network. Device 400 further includes communication interface(s) 404 which can be implemented as any one or more of a serial and/or parallel interface, a wireless interface, any type of network interface, a modem, and as any other type of communication interface. A wireless interface enables client device 400 to receive control input commands 406 and other information from an input device, such as from remote control device 408, PDA (personal digital assistant) 410, cellular phone 412, or from another infrared (IR), 802.11, Bluetooth, or similar RF input device.

A network interface provides a connection between the client device 400 and a communication network by which other electronic and computing devices can communicate data with device 400. Similarly, a serial and/or parallel interface provides for data communication directly between client device 400 and the other electronic or computing devices. A modem facilitates client device 400 communication with other electronic and computing devices via a conventional telephone line, a DSL connection, cable, and/or other type of connection.

Client device 400 also includes one or more processors 414 (e.g., any of microprocessors, controllers, and the like) which process various computer executable instructions to control the operation of device 400, to communicate with other electronic and computing devices, and to implement embodiments of DVR content skip navigation. Client device 400 can be implemented with computer readable media 416, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 416 provides data storage mechanisms to store various information and/or data such as software applications and any other types of information and data related to operational aspects of client device 400. For example, an operating system 418 and/or other application programs 420 can be maintained as software applications with the computer readable media 416 and executed on processor(s) 414 to implement embodiments of DVR content skip navigation.

For example, client device 400 can be implemented to include a program guide application 422 that is implemented to process program guide data 424 and generate program guides for display which enable a viewer to navigate through an onscreen display and locate broadcast programs, recorded programs, video on-demand programs and movies, interactive game selections, network-based applications, and other media access information or content of interest to the viewer. The application programs 420 can include a programmed application to implement features and embodiments of DVR content skip navigation as described herein. Alternatively, the programmed application can be implemented as an integrated module or component of the program guide application 422 to implement embodiments of DVR content skip navigation. The client device 400 can also include a DVR system 426 with playback application 428, and recording media 430 to maintain recorded media content 432.

The client device 400 also includes an audio and/or video output 434 that provides audio and video to an audio rendering and/or display system 436, or to other devices that process, display, and/or otherwise render audio, video, and image data. Video signals and audio signals can be communicated from device 400 to a television 438 (or to other types of display devices) via an RF (radio frequency) link, S-video link, composite video link, component video link, analog audio connection, or other similar communication link.

FIG. 5 illustrates an exemplary entertainment and information system 500 in which an IP-based television environment can be implemented, and in which embodiments of DVR content skip navigation can be implemented. System 500 facilitates the distribution of program content, program guide data, and advertising content to multiple viewers and to multiple viewing systems. System 500 includes a content provider 502 and television-based client systems 504(1−N) each configured for communication via an IP-based network 506. Each television-based client system 504(1N) is an example of the television-based client system 306(1) described with reference to FIG. 3. Each of the television-based client systems 504(1−N) can receive one or more data streams from content provider 502 and then arbitrate stream allocation to distribute the data streams, one each, to one or more other satellite client devices in a viewing system.

The network 506 can be implemented as a wide area network (e.g., the Internet), an intranet, a Digital Subscriber Line (DSL) network infrastructure, or as a point-to-point coupling infrastructure. Additionally, network 506 can be implemented using any type of network topology and any network communication protocol, and can be represented or otherwise implemented as a combination of two or more networks. A digital network can include various hardwired and/or wireless links 508(1−N), routers, gateways, and so on to facilitate communication between content provider 502 and the client systems 504(1−N). The television-based client systems 504(1−N) receive program content, program guide data, advertising content, closed captions data, and the like from content server(s) of the content provider 502 via the IP-based network 506.

System 500 includes a media server 510 that receives program content from a content source 512, program guide data from a program guide source 514, and advertising content from an advertisement source 516. In an embodiment, the media server 510 represents an acquisition server that receives the audio and video program content from content source 512, an EPG server that receives the program guide data from program guide source 514, and/or an advertising management server that receives the advertising content from the advertisement source 516.

The content source 512, the program guide source 514, and the advertisement source 516 control distribution of the program content, the program guide data, and the advertising content to the media server 510 and/or to other television-based servers. The program content, program guide data, and advertising content is distributed via various transmission media 518, such as satellite transmission, radio frequency transmission, cable transmission, and/or via any number of other wired or wireless transmission media. In this example, media server 510 is shown as an independent component of system 500 that communicates the program content, program guide data, and advertising content to content provider 502. In an alternate implementation, media server 510 can be implemented as a component of content provider 502.

Content provider 502 is representative of a headend service in a television-based content distribution system, for example, that provides the program content, program guide data, and advertising content to multiple subscribers (e.g., the television-based client systems 504(1−N)). The content provider 502 can be implemented as a satellite operator, a network television operator, a cable operator, and the like to control distribution of program and advertising content, such as movies, television programs, commercials, music, and other audio, video, and/or image content to the client systems 504(1−N).

Content provider 502 includes various components to facilitate media data processing and content distribution, such as a subscriber manager 520, a device monitor 522, and a content server 524. The subscriber manager 520 manages subscriber data, and the device monitor 522 monitors the client systems 504(1−N) (e.g., and the subscribers), and maintains monitored client state information.

Although the various managers, servers, and monitors of content provider 502 (to include the media server 510 in one embodiment) are illustrated and described as distributed, independent components of content provider 502, any one or more of the managers, servers, and monitors can be implemented together as a multi-functional component of content provider 502. Additionally, any one or more of the managers, servers, and monitors described with reference to system 500 can implement features and embodiments of DVR content skip navigation.

The television-based client systems 504(1−N) can be implemented to include a client device 526 and a display device 528 (e.g., a television). A client device 526 of a television-based client system 504 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 504(N) is implemented with a computing device 530 as well as a client device 526. Additionally, any of the client devices 526 of a client system 504 can implement features and embodiments of DVR content skip navigation as described herein.

Although embodiments of DVR content skip navigation have been described in language specific to structural features and/or methods, it is to be understood that the subject of the appended claims is not necessarily limited to the specific features or methods described. Rather, the specific features and methods are disclosed as exemplary implementations of DVR content skip navigation.

1. A video system, comprising:
a video processing system configured to render video for display at a playback speed for viewing;
a video control application configured to:
receive an input to initiate a fast review of the video for a designated duration during which the video is viewable; and
automatically resume display of the video at the playback speed after the designated duration of fast review.

2. A video system as recited in claim 1, wherein the video control application is further configured to receive the input as a user-selectable skip input to initiate the fast review of the video.

3. A video system as recited in claim 2, wherein the video control application is further configured to automatically resume display of the video at the playback speed without receiving an additional user-selectable input.

4. A video system as recited in claim 2, wherein the video control application is further configured to receive an additional user-selectable skip input that is processed with the user-selectable skip input to initiate the fast review of the video for twice the designated duration.

5. A video system as recited in claim 1, wherein the video control application is further configured to initiate the fast review as a skip advance to fast-forward through the video, and automatically resume display of the video at the playback speed after fast-forwarding through the video.

6. A video system as recited in claim 1, wherein the video control application is further configured to initiate the fast review as a skip reverse to rewind through the video, and automatically resume display of the video at the playback speed after rewinding through the video.

7. A video system as recited in claim 1, wherein the video control application is further configured to receive the input as a continuous fast-forward input signal to initiate the fast review of the video, and wherein the designated duration is a time duration during which the continuous fast-forward input signal is received.

8. A video system as recited in claim 7, wherein the video control application is further configured to automatically resume display of the video at the playback speed when the continuous fast-forward input signal is no longer received.

9. A television-based client device comprising the video system as recited in claim 1.

10. A method, comprising:
rendering video for display at a playback speed for viewing; and
receiving an input to initiate a fast review of the video for a designated duration such that the video is viewable during the fast review, and such that said rendering the video returns to the playback speed after the designated duration of fast review.

11. A method as recited in claim 10, wherein receiving the input includes receiving a user-selectable skip input via a television-based remote control device.

12. A method as recited in claim 11, wherein the video automatically returns to the playback speed after the designated duration of fast review without receiving an additional user-selectable input.

13. A method as recited in claim 10, wherein the fast review is a skip advance to fast-forward through the video for the designated duration, and wherein said rendering the video automatically returns to the playback speed after fast-forwarding through the video for the designated duration.

14. A method as recited in claim 10, wherein the fast review is a skip reverse to rewind through the video for the designated duration, and wherein said rendering the video automatically returns to the playback speed after rewinding through the video for the designated duration.

15. A method as recited in claim 10, wherein receiving the input includes receiving a continuous fast-forward input signal to initiate fast-forwarding through the video, and wherein the designated duration is a time duration over which the continuous fast-forward input signal is received.

16. A method as recited in claim 15, wherein said rendering the video automatically returns to the playback speed when the continuous fast-forward input signal is no longer received.

17. A method as recited in claim 10, further comprising receiving an additional input that is processed with the input to initiate the fast review of the video for twice the designated duration.

18. One or more computer readable media comprising computer executable instructions that, when executed, direct a television-based client device to:
receive video to be processed for display at a playback speed for viewing;
receive a skip input via a television-based remote control device to initiate a fast review of the video for a skip duration during which the video is viewable; and
automatically resume display of the video at the playback speed after the skip duration of fast review without receiving an additional input via the television-based remote control device.

19. One or more computer readable media as recited in claim 18, further comprising computer executable instructions that, when executed, direct the television-based client device to:
receive the skip input as a skip advance input;
fast-forward through the video for the skip duration; and
automatically resume display of the video at the playback speed after fast-forwarding through the video for the skip duration.

20. One or more computer readable media as recited in claim 18, further comprising computer executable instructions that, when executed, direct the television-based client device to:
receive the skip input as a skip reverse input;
rewind through the video for the skip duration; and
automatically resume display of the video at the playback speed after rewinding through the video for the skip duration.
